(19) United States
(12) Patent Application Publication
(10) Pub. No.: US 2020/0086358 A1
(43) Pub. Date: Mar. 19, 2020

(54) LIQUID DISPERSER

(71) Applicants: Thomas MIHALIK, Geneva, OH (US); Micah MIHALIK, Geneva, OH (US)

(72) Inventors: Thomas MIHALIK, Geneva, OH (US); Micah MIHALIK, Geneva, OH (US)

(21) Appl. No.: 16/572,807

(22) Filed: Sep. 17, 2019

Related U.S. Application Data
(60) Provisional application No. 62/732,042, filed on Sep. 17, 2018.

(51) Int. Cl. B08B 3/10; F16L 3/12; B05B 1/26; B08B 9/00

(52) U.S. Cl. CPC B08B 3/108; B08B 9/00; B05B 1/265; F16L 3/1222

(57) ABSTRACT

Liquid dispersers having a receiver fitting sized to receive a pipe or hose at an inlet and having an outlet through which liquids from the pipe or hose are expelled and dispersion head operably attached to the fitting receiver and spaced from and opposite to the outlet of the receiver fitting designed to disperse the liquid laterally away from the liquid disperser and systems and methods incorporating the same are described herein.

### CROSS-REFERENCE TO RELATED APPLICATIONS

This application claims priority from U.S. Provisional No. 62/732,042 entitled “Liquid Disperser” filed on Sep. 17, 2018, which is hereby incorporated by reference in its entirety.

### GOVERNMENT INTERESTS

Not applicable

### PARTIES TO A JOINT RESEARCH AGREEMENT

Not applicable

### INCORPORATION OF MATERIAL ON COMPACT DISC

NOT APPLICABLE

### BACKGROUND

Not applicable

### SUMMARY OF THE INVENTION

Various embodiments of the invention are directed to a liquid disperser for cleaning a cavity, systems including the liquid disperser, and methods for using such systems.

Some embodiments are directed to a liquid disperser including a receiver fitting sized to receive a pipe or hose. The receiver fitting may have an outlet and a dispersion head may be operably attached to the fitting receiver and spaced from the outlet of the receiver fitting. The dispersion head may include a deflector opposite the outlet of the receiver fitting. In some embodiments, the deflector may be at least partially flat. In some embodiments, the deflector may be at least partially concave or convex, and in certain embodiments, the deflector may have a concave half torus shape. In some embodiments, the dispersion head may include a spike or dispersion head post extending toward the outlet of the receiver fitting, and in certain embodiments, the spike or dispersion head post may extend into the outlet of the receiver fitting. In some embodiments, the liquid disperser further includes a hanging means operably attached to the dispersion head. In some embodiments, the disperser may include connecting rods operably connecting the dispersion head and the fitting receiver. In some embodiments, the disperser may include comprising lateral posts, post stabilizers, or wings operably attached to the dispersion head. In some embodiments, the receiver fitting may be sized to receive a pipe or hose having an inner diameter of about 0.5 inches to about 2 inches. In some embodiments, the receiver fitting may include one or more clamps operably attached to the receiver fitting positioned to hold the pipe or hose onto the liquid disperser, and in some embodiments, the receiver fitting may include machined threads sized to receive threaded components or a pressure fitting.

Further embodiments are directed to a system including a liquid disperser, a submersible pump, a pipe or hose connecting the submersible pump to the liquid disperser, and a rope or chain for suspending the liquid disperser, pipe or hose, and submersible pump in a cavity. In various embodiments, liquid disperser may include the various components described above. In certain embodiments, the cavity may be a dry well, a man hole, and a drainage basin.

Other embodiments are directed to a method for cleaning a cavity including the steps of treating standing water in the cavity, introducing a submersible pump having a pipe or hose connecting the submersible pump to a liquid disperser, pumping the standing water through the submersible pump and pipe or hose to the liquid disperser, deflecting standing water from the liquid disperser to walls of the cavity, and circulating the standing water by continually pumping the standing water. In various embodiments, liquid disperser may include the various components described above. In some embodiments, the step of circulating the standing water is carried out for about 1 hour to about 36 hours. In some embodiments, the step of treating standing water may include introducing a chemical or biological agent into the standing water. In some embodiments, the cavity may be a dry well, a man hole, and a drainage basin.

### DESCRIPTION OF THE DRAWINGS

Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well known process operations have not been described in details so as to not unnecessarily obscure the present invention.

FIG. 1 is a schematic showing an example of a liquid disperser of embodiments of the invention.

FIG. 2 is a schematic showing an example of a liquid disperser of embodiments of the invention.

### DETAILED DESCRIPTION

Various aspects now will be described more fully hereinafter. Such aspects may, however, be embodied in many different forms and should not be construed as limited to the embodiments set forth herein; rather, these embodiments are provided so that this disclosure will be thorough and complete, and will fully convey its scope to those skilled in the art.

Where a range of values is provided, it is intended that each intervening value between the upper and lower limit of that range and any other stated or intervening value in that stated range is encompassed within the disclosure. For example, if a range of 1 mm to 8 mm is stated, 2 mm, 3 mm, 4 mm, 5 mm, 6 mm, and 7 mm are also intended to be explicitly disclosed, as well as the range of values greater than or equal to 1 mm and the range of values less than or equal to 8 mm.

All percentages, parts and ratios are based upon the total weight of the topical compositions and all measurements made are at about 25° C., unless otherwise specified.

The singular forms “a,” “an,” and “the” include plural referents unless the context clearly dictates otherwise. Thus, for example, reference to a “polymer” includes a single polymer as well as two or more of the same or different polymers; reference to an “excipient” includes a single excipient as well as two or more of the same or different excipients, and the like.

The word “about” when immediately preceding a numerical value means a range of plus or minus 10% of that value, e.g, “about 50” means 45 to 55, “about 25,000” means 22,500 to 27,500, etc, unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g, more than 49.5 to less than 52.5. Furthermore, the phrases “less than about” a value or “greater than about” a value should be understood in view of the definition of the term “about” provided herein.

By hereby reserving the right to proviso out or exclude any individual members of any such group, including any sub-ranges or combinations of sub-ranges within the group, that can be claimed according to a range or in any similar manner, less than the full measure of this disclosure can be claimed for any reason. Further, by hereby reserving the right to proviso out or exclude any individual substituents, analogs, compounds, ligands, structures, or groups thereof, or any members of a claimed group, less than the full measure of this disclosure can be claimed for any reason. Throughout this disclosure, various patents, patent applications and publications are referenced. The disclosures of these patents, patent applications and publications in their entireties are incorporated into this disclosure by reference in order to more fully describe the state of the art as known to those skilled therein as of the date of this disclosure. This disclosure will govern in the instance that there is any inconsistency between the patents, patent applications and publications cited and this disclosure.

For convenience, certain terms employed in the specification, examples and claims are collected here. Unless defined otherwise, all technical and scientific terms used in this disclosure have the same meanings as commonly understood by one of ordinary skill in the art to which this disclosure belongs.

Various embodiments of the invention are directed to liquid dispersers for mixing and dispersing liquids, systems for mixing and dispersing liquids, and methods for using the same.

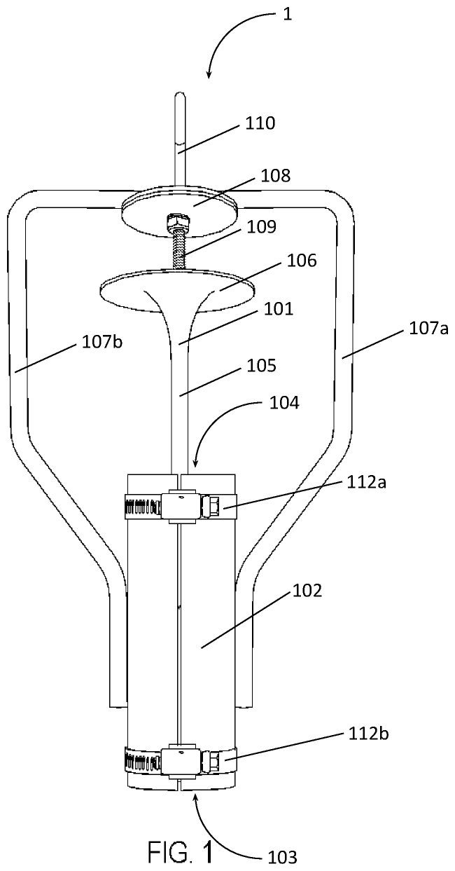

FIG. 1 illustrates an example of the liquid dispersers 1 of the invention. Such dispersers 1 may generally include a dispersion head 101 operably associated to a fitting receiver 102. The fitting receiver 102 may be sized to receive a pipe or hose that delivers liquids for mixing and dispersing to the liquid disperser 1. The fitting receiver 102 may include an inlet 103 into which a pipe or hose is introduced and received by the fitting receiver 102 and an outlet 104 through which liquids are expelled. The fitting receiver 102 may include one or more clamps 112a,112b for holding the pipe or hose onto the liquid disperser 1. In other embodiments, the fitting receiver 102 may include machined threads (not pictured) sized to receive threaded components of, for example, a threaded pipe fitting or ferrule operably attached to a pipe or hose, and in some embodiments, the fitting receiver 102 may be designed to receive a pressure fitting (not pictured). Embodiments of the fitting receiver 102 are not limited to these examples and encompass any means for attaching a pipe or hose to the liquid disperser 1. In various embodiments, the fitting receiver 102 may be sized to receive a pipe or hose having an inner diameter of about 0.5 inches to about 2 inches. Thus, the fitting receiver 102 may be capable of receiving and attaching to standard ½ inch, ¾ inch, 1 inch, 1¼ inch, 1½ inch, or 2-inch piping, for example, PVC (polyvinyl chloride) piping.

The dispersion head 101 of various embodiments may be designed to contact a stream of water and spray the water laterally away from the liquid disperser 1. The dispersion head 101 may be spaced from and opposing the outlet 104 of the fitting receiver 102. In use, liquids for mixing and dispersion may be expelled from the outlet and impinge upon the dispersion head 101, which distribute the liquid over an area surrounding the liquid disperser 1. The dispersion head 101 may have various shapes. For example, the dispersion head 101 illustrated in FIG. 1 includes a spike 105 and a deflector 106. The spike 105 is optional and may improve directional flow and water pressure by Venturi effect of the water expelled from the outlet 104 of the fitting receiver 102. The deflector 106 contacts water expelled from the outlet 104 and disperses is laterally away from the liquid disperser 101. The deflector 106 may have any shape. For example, the deflector 106 may be at least partially flat or have concave or convex curvatures. In certain embodiments, the defector 106 may have a concave half torus shape surrounding a spike 105. In some embodiments, the deflector 106 may include tines (not pictured) spaced about its periphery, with openings or spaces therebetween. The number, spacing, and shape of the tines and openings may be sized and positioned to improve distribution of water spray over the area surrounding the liquid disperser 1.

The dispersion head 101 may be operably connected to the fitting receiver 102 by any means. For example, as illustrated in FIG. 1, the dispersion head 101 is attached to the fitting receiver 102 by connecting rods or posts 107a,107b operably connected to the fitting receiver 102 and the dispersion head 101. The connecting rods or posts 107a,107b can be operably connected to the fitting receiver 102 by various means, including, for example, welding, rivets, screws or bolts, adhesives, pressure fittings, and the like and combinations thereof, and in some embodiments, the connecting rods or posts 107a,107b may be molded components of the receiver fitting 102, making the connecting rods or posts 107a,107b and receiver fitting 102 components of a single machined or molded part.

The connecting rods or posts 107a,107b may directly attach to the dispersion head 101. In some embodiments, a top connector 108 may be attached to the connecting rods or posts 107a,107b that operably connect the connecting rods or posts 107 a,107b to the dispersion head 101. As illustrated in FIG. 1 the top connector 108 may include a movable connector 109 that is attached to the dispersion head 101 and allows the dispersion head 101 to be moved vertically closer to and away from the output 104 of the fitting receiver 102. The movable connector 109 may include a screw body, pressure fitting, or any means for moving the dispersion head 101.

The liquid disperser 1 of various embodiments may include a hanging means 110 such as a hook, eye, or carabiner attached to the top of the liquid disperser 1. In use, the hanging means 110 may allow the liquid disperser 1 to be suspended in a cavity, such as a dry well, man hole, drainage basin, or the like, using rope or chain.

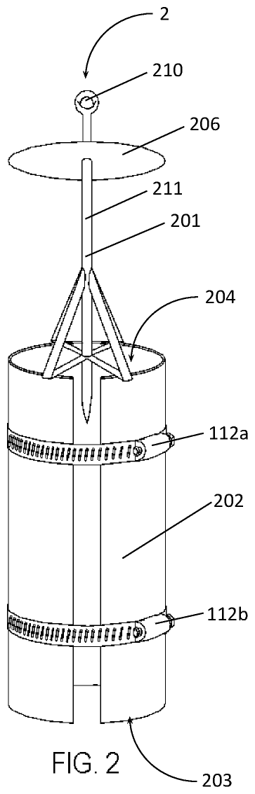

FIG. 2 illustrates another embodiment of the liquid disperser 2 having many of the same elements described above with regard to FIG. 1. In various embodiments, elements described in regard to FIG. 1 that are not illustrated in FIG. 2 can be incorporated into the liquid disperser 2 of FIG. 2.

FIG. 2 illustrates a liquid disperser 2 having a dispersion head 201 operably associated to a fitting receiver 202. Like the fitting receiver 102 of FIG. 1, The fitting receiver 202 may be sized to receive a pipe or hose having standard sizes and may include an inlet 203 and an outlet 204 through which liquids are expelled. Embodiments of the fitting receiver 202 may encompass any means for attaching a pipe or hose to the liquid disperser 2. For example, the fitting receiver 202 may include one or more clamps 212a,212b for holding the pipe or hose onto the liquid disperser 2, or the fitting receiver 202 may be machined threads or designed to receive a pressure fitting.

The dispersion head 201 of various embodiments may be designed to contact a stream of water and spray the water laterally away from the liquid disperser 2. The dispersion head 201 may be spaced from and opposing the outlet 204 of the fitting receiver 202, and liquids for mixing and dispersion may be expelled from the outlet and impinge upon the dispersion head 201, which distribute the liquid over an area surrounding the liquid disperser 2. The dispersion head 201 may have various shapes. For example, the deflector 206 may be at least partially flat or have concave or convex curvatures. In certain embodiments, the defector 206 may have a concave half torus shape. In some embodiments, the deflector 206 may include tines (not pictured).

The liquid disperser 2 of FIG. 2 includes a dispersion head post 211 extending from and operably attached to the fitting receiver 202 and the deflector 206. In some embodiments, the dispersion head post 211 may include an integral hanging means 210 such as an eye (pictured), hook, or carabiner. The dispersion head post 211 can be attached to the fitting receiver 202 by any means. For example, the dispersion head post 211 may be directly attached to the fitting receiver 202 by lateral posts 213a,213b,213c,213d and lateral post stabilizers 214a,214b,214c,214d or wings (not pictured). The lateral posts, post stabilizers, and wings may be sized and shaped to hold the dispersion head post 211 and deflector 206 in place while not interrupting the flow of fluid from the outlet 204 of the fitting receiver 202 to the deflector 206. In various embodiments, the lateral posts, post stabilizers, and wings may be attached to the dispersion head post 211 and fitting receiver 202 by means including, for example, welding, rivets, screws or bolts, adhesives, pressure fittings, and the like and combinations thereof, and in some embodiments, lateral posts, post stabilizers, wings, and dispersion head post 211 molded components of the receiver fitting 202, making the lateral posts, post stabilizers, wings, dispersion head post 211 and fitting receiver 202 components of a single machined or molded part. In still other embodiments, the deflector 206 may be molded with the lateral posts, post stabilizers, wings, dispersion head post 211 and fitting receiver 202, making all of the elements of the liquid disperser 2 a single molded part.

Further embodiments are directed to a system for cleaning a cavity, such as a dry well, manhole, drainage basin, or the like. Such systems may include a liquid disperser such as those described above and illustrated in FIG. 1 and FIG. 2, a submersible pump, a pipe or hose connecting the submersible pump to the liquid disperser, and a rope or chain for suspending the liquid disperser, pipe or hose, and submersible pump in the cavity. The rope or chain may hold the liquid disperser above liquids contained within the cavity while submerging the submersible pump in the liquids contained in the cavity. In use, liquids from within the cavity are pumped from the cavity to the liquid disperser, which deflects the liquid onto the walls of the cavity and back into the liquids in the cavity, allowing circulation and mixing of the liquids while the submersible pump is pumping liquid.

Additional embodiments are directed to methods for cleaning a cavity, such as a dry well, manhole, drainage basin, or the like having standing water within the cavity. Such methods may generally include treating the standing water with a chemical or biological agent for cleaning the cavity, introducing a submersible pump having a pipe or hose connecting the submersible pump to a liquid disperser such as those described above and illustrated in FIG. 1 and FIG. 2, pumping the standing water through the submersible pump and pipe or hose to the liquid disperser, deflecting standing water from the liquid disperser to walls of the cavity, and circulating the standing water by continually pumping the standing water. Circulating the standing water can be carried out for any amount of time sufficient to allow the cavity to be sufficiently cleaned. For example, circulating can be carried out for about 1 hour to about 36 hours, about 5 hours to about 24 hours or any time period encompassed by these example ranges.

1. A liquid disperser comprising a receiver fitting sized to receive a pipe or hose, the receiver fitting having an outlet and a dispersion head operably attached to the fitting receiver and spaced from the outlet of the receiver fitting, the dispersion head comprising a deflector opposite the outlet of the receiver fitting.

2. The liquid disperser of claim 1, wherein the deflector is at least partially flat.

3. The liquid disperser of claim 1, wherein the deflector has a concave curvature or convex curvature.

4. The liquid disperser of claim 1, wherein the defector has a concave half torus shape surrounding.

5. The liquid disperser of claim 1, wherein the dispersion head comprises a spike or dispersion head post extending toward the outlet of the receiver fitting.

6. The liquid disperser of claim 5, wherein the spike or dispersion head post extends into the outlet of the receiver fitting.

7. The liquid disperser of claim 1, further comprising a hanging means operably attached to the dispersion head.

8. The liquid disperser of claim 1, further comprising connecting rods operably connecting the dispersion head and the fitting receiver.

9. The liquid disperser of claim 1, further comprising lateral posts, post stabilizers, or wings operably attached to the dispersion head and the fitting receiver.

10. The liquid disperser of claim 1, wherein the receiver fitting is sized to receive a pipe or hose having an inner diameter of about 0.5 inches to about 2 inches.

11. The liquid disperser of claim 1, further comprising one or more clamps operably attached to the receiver fitting positioned to hold the pipe or hose onto the liquid disperser.

12. The liquid disperser of claim 1, wherein the receiver fitting comprises machined threads sized to receive threaded components or a pressure fitting

13. A system comprising a liquid disperser, a submersible pump, a pipe or hose connecting the submersible pump to the liquid disperser, and a rope or chain for suspending the liquid disperser, pipe or hose, and submersible pump in a cavity.

14. The system of claim 13, wherein the cavity is selected from the group consisting of a dry well, a man hole, and a drainage basin.

15. A method for cleaning a cavity comprising:
treating standing water in the cavity,
introducing a submersible pump having a pipe or hose connecting the submersible pump to a liquid disperser,
pumping the standing water through the submersible pump and pipe or hose to the liquid disperser,
deflecting standing water from the liquid disperser to walls of the cavity, and circulating the standing water by continually pumping the standing water.

16. The method of claim 15, wherein circulating the standing water is carried out for about 1 hour to about 36 hours.

17. The method of claim 15, wherein treating standing water comprising introducing a chemical or biological agent into the standing water.

18. The method of claim 15, wherein the cavity is selected from the group consisting of a dry well, a man hole, and a drainage basin.
